(19) United States
(12) Patent Application Publication
(10) Pub. No.: US 2017/0261300 A1
(43) Pub. Date: Sep. 14, 2017

(54) MEASURING TAPE

(71) Applicant: Klein Tools, Inc., Lincolnshire, IL (US)

(72) Inventors: Gerhard A. Jost, Antioch, IL (US); David W. Mueller, Lake Zurich, IL (US)

(73) Assignee: Klein Tools, Inc., Lincolnshire, IL (US)

(21) Appl. No.: 15/451,635

(22) Filed: Mar. 7, 2017

Related U.S. Application Data
(60) Provisional application No. 62/306,217, filed on Mar. 10, 2016.

(51) Int. Cl. G01B 3/10

(52) U.S. Cl. CPC G01B 3/1084; G01B 3/1041; G01B 3/1082; G01B 2003/1043

(57) ABSTRACT

A tape measure marking system includes indicia along the length of a measuring tape positioned at regular distance intervals along the length of the measuring tape, with the indicia located at some regular repeating intervals along the tape being visually discernible relative to indicia at other regular repeating intervals along the tape to allow for easier visual identification of thicker intervals with respect to the other indicia.

### FIELD OF THE DISCLOSURE

This disclosure relates to measuring tapes and, more particularly, to a retractable tape measure.

### BACKGROUND

Retractable tape measures typically include a measuring tape that retracts in a housing and selectively extends to permit measurements by the user. The tape, which is typically made of metal, is often painted and includes distance markings thereon that begin at one end and incrementally increase towards another end. Accordingly, typical tape measures consist of a long, thin strip of material, usually spring steel, and are marked with regularly spaced indicia. Tape measures feature indicia delineating standardized distance intervals over the length of the tape measure, most commonly inches and fractions thereof or centimeters and millimeters.

Tape measures are often used at a moderate distance from the user's eyes, for example, to measure on a floor or on a ceiling, and the indicia can be difficult to discern at such distances. Especially in the case of fractional inches, which are often segmented into quarters, eighths, sixteenths, and thirty-seconds of an inch, identifying the individual indicia often requires close visual inspection by the user, and proximity of the user to the tape to get an accurate reading, which is not always possible or desirable by the user.

### BRIEF DESCRIPTION OF THE SEVERAL VIEWS OF THE DRAWINGS

FIG. 1 is a perspective view of a typical tape measure present in the prior art.

FIGS. 2-4 depict respective top side views of various known tape measure indicia present in the prior art.

FIG. 5 is a top side view of a tape measure in accordance with the disclosure.

FIGS. 6-11 are views from various perspectives of a tape measure in accordance with the disclosure.

FIGS. 12-15 are enlarged, detail views of four different alternative embodiments in accordance with the disclosure.

### DETAILED DESCRIPTION

The present disclosure is applicable to length measurement devices that provide visual indicia for determining a length to be measured by a user. While the embodiments described herein relate to a retractable tape measure, any other measurement device such as rulers and the like may benefit from the disclosure.

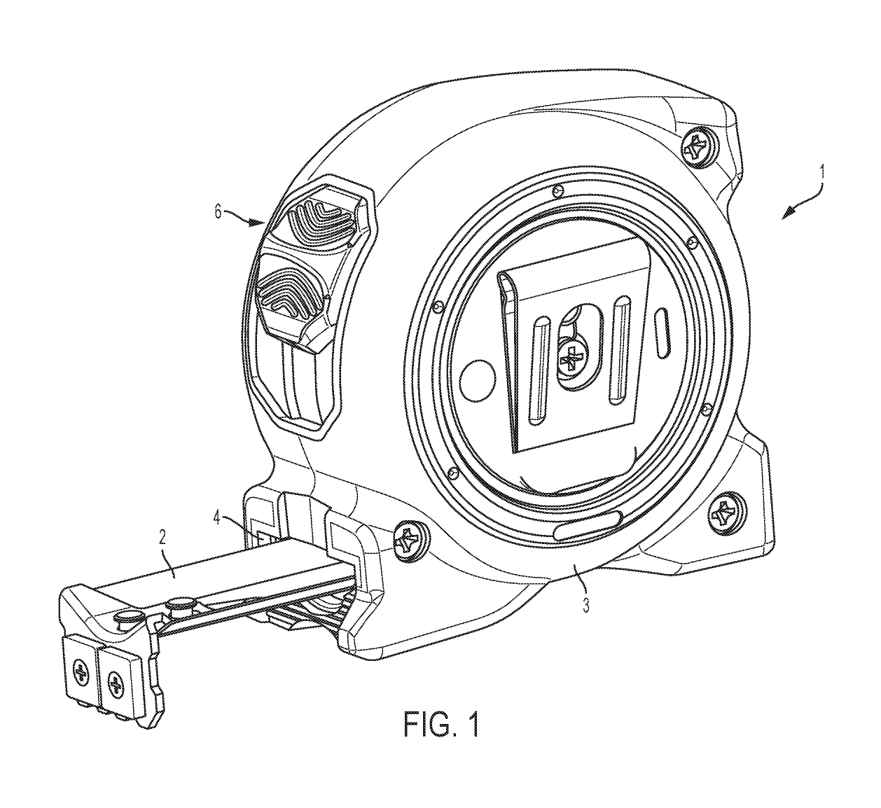

An exemplary embodiment of a tape measure 1 is illustrated in FIG. 1. The tape measure 1 is of a typical construction that houses a long thin tape 2, which is typically made of steel and which is wound inside an enclosure 3 to retract when not in use by a coil spring (not shown). The enclosure 3 forms a slot 4 through which the end of the tape 2 can be extracted from and returned into the enclosure 3. The extended portion of the tape 2 is tangentially related to a remaining, coiled portion of the tape 2 that remains within the enclosure 3. In the illustrated embodiment, the tape measure 1 includes a bias spring (not shown) that is disposed and operates within the enclosure 3 to urge the tape 2 to assume a coiled position within the enclosure 3. In use, the spring permits the automatic retrieval or recoiling of the tape 2 back into the enclosure 3 when the tape is released. To engage the tape to a working, retracted length, and to also release the tape to recoil, a stop button 6 holds the tape 2 and prevents it from reentering the enclosure 3 when a length of tape 2 is dispensed from the enclosure 3 by a user.

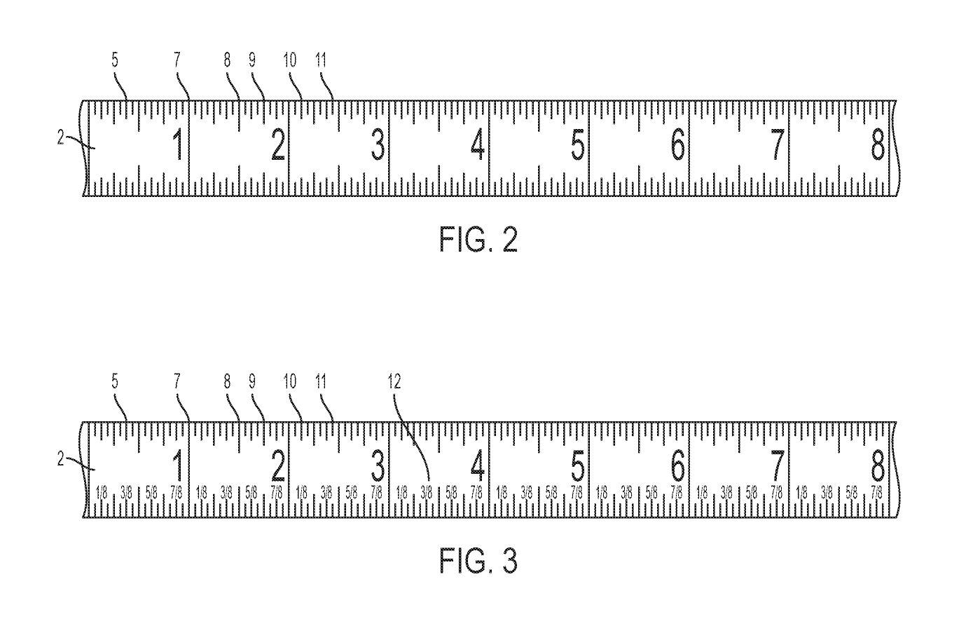

The tape 2 includes markings or other indicia thereon that are created in fixed intervals to denote known or standard measurement units. The measurement units can be based on a metric, customary or other measurement standard. In the illustrated embodiments, customary units are used to mark the various tapes presented, but it should be appreciated that markings in accordance with a metric measurement system, or other measurement systems may be used. FIG. 2 shows the most common form of indicia 5 used in the United States, which accord to a standard or customary measurement system that includes feet, inches and various inch subdivisions. The primary purpose of the tape measure 1 is to provide a means to measure length, and accordingly the tape 2 is marked at regular intervals with indicia 5 to permit the user to measure by laying the tape 2 alongside an object, aligning a free end of the tape with an edge of the object to be measured, and reading the indicia 5 at another end of the object or at a position along the object where a cut may be made to a desired length.

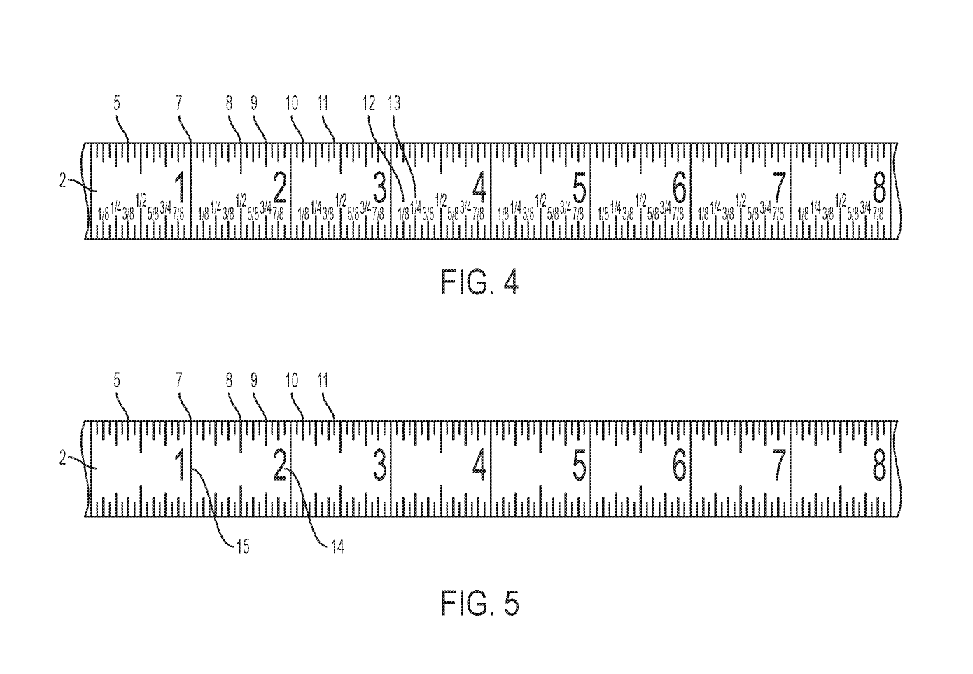

As shown, the tape 2 shown in FIG. 2, and also in FIGS. 3 and 4, feature indicia at one-inch intervals 7 and also indicia at every half of an inch 8, quarter of an inch 9, eighth of an inch 10, and sixteenth of an inch 11. The most common method to discern whether indicia 5 are at intervals of an eighth inch 10, quarter inch 9, sixteenth inch 11, or half of an inch 8 is to examine the length of the indicia 5, which tend to be longer for larger subdivisions of an inch, such that the half inch indicia 8 are longer than the quarter inch indicia 9, which are longer than the eight inch indicia 10, which are longer than the sixteenth inch indicia 11. These markings can be difficult to read, particularly at a distance, low lighting conditions and, as is often the case, when the indicia is at least partially obscured by debris that has accumulated on the tape 2 during use.

FIG. 3 depicts one prior art attempt at providing a visual distinction between the various indicia markings denoting inch subdivisions. In this embodiment, indicia 5 located at every eighth-inch location 10 along the tape have an accompanying fractional identifier 12 to assist the user in accurately reading the tape 2. FIG. 4 depicts a similar prior art implementation of the same type, with fractional identifiers at each eighth-inch interval 12 along the tape 2, and also fractional identifiers at each quarter-inch interval 13 of the tape 2. Limited by the width of the tape and also by the relatively small intervals along the length of the tape, the various fractional identifiers 12 are difficult to read at a distance because they are created using a small font size and are relatively close together. Moreover, during use, portions of the tape 2 may become worn or obscured by friction and wear against a brake pad (not shown) that engages the tape 2 while the tape is at an extended position relative to the housing or enclosure 3 when the stop button 6 is activated.

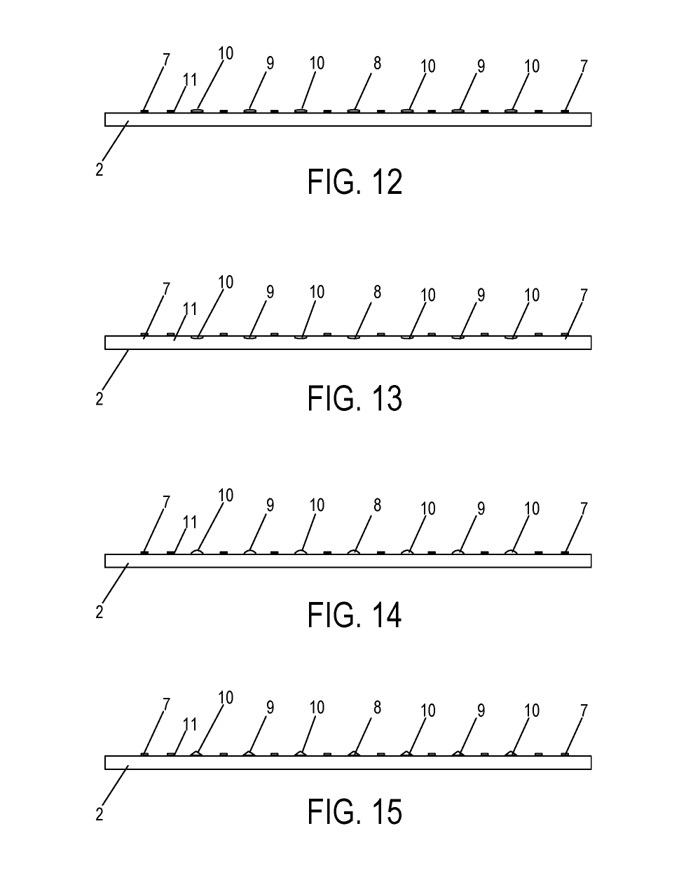

To make the various interval markings on a measuring tape more visible to a user, for example, at a distance, low lighting conditions and, as is often the case, when the indicia is at least partially obscured by debris that has accumulated on the tape 2 during use, an improved tape 2 is shown in FIG. 5. In this embodiment, indicia 5 are formed at each half-inch internal 8 along the length of the tape 2, and also at each quarter-inch interval 9, and eighth-inch interval 10, which indicia 5 are noticeably thicker than corresponding indicia demarking whole inch intervals 7 and sixteenth-inch intervals 11 along the length of the tape 2. By noticeably thicker, it is contemplated that the thicker intervals are at least 50% or more wider than the remaining indicia, and may also be formed using a different, e.g., darker color, or other visually discerning feature, including but not limited to being made of a fluorescent paint or material, being raised or embossed, being made from a light-reflective material, being concave in shape, being convex in shape and having a semi-circular or triangular cross section, and others. Enlarged, detailed views of a tape 2 having different markings are shown in FIGS. 12-15, in which the half inch intervals 8, the quarter-inch intervals 9 and the eighth-inch intervals 10 are embossed (FIG. 12), concave or etched into the tape (FIG. 13), have a semi-circular shape (FIG. 14) or a triangular shape (FIG. 15). Any of these patterns or shapes facilitates discerning the thicker markings from the thinner ones, even at a distance or by touch. In a preferred embodiment, the whole inch intervals 7 along the length of the tape 2 are not made thicker because the indicia at these intervals 15 extend across the entire tape 2 and feature large-print numbers 14 to identify the whole inch indicia intervals 7, but these could be made thicker in other embodiments.

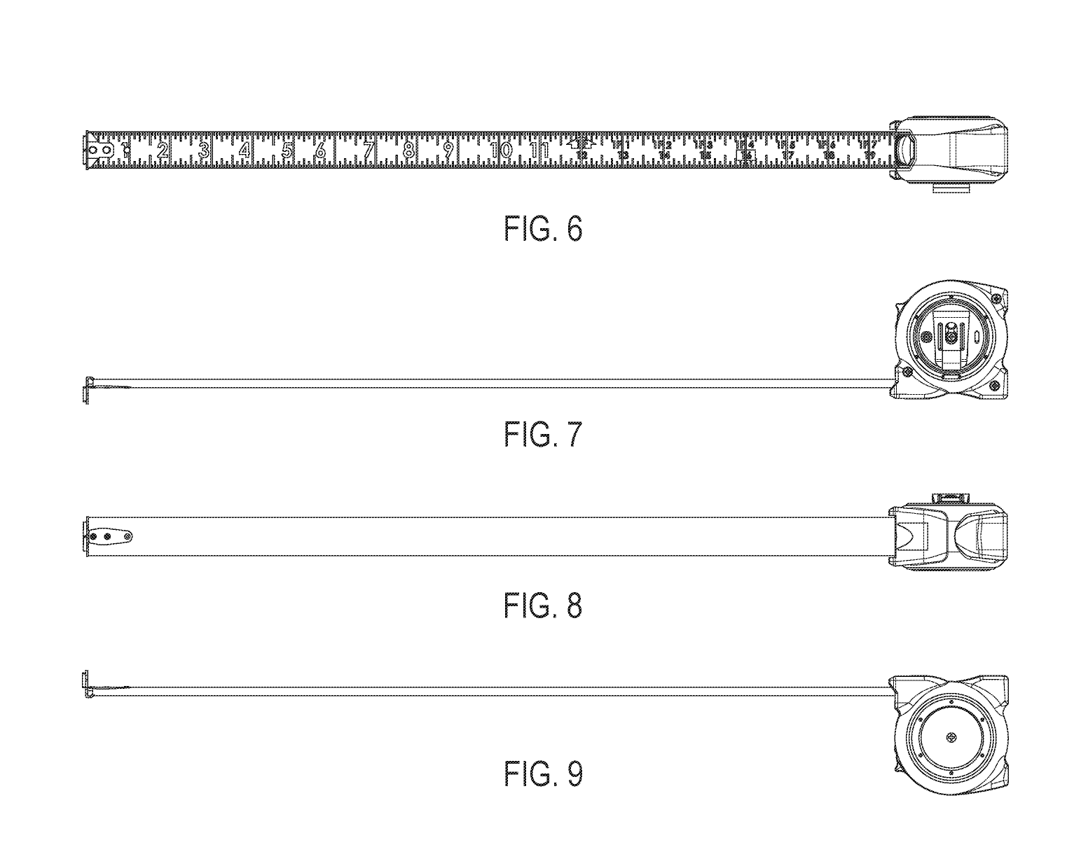

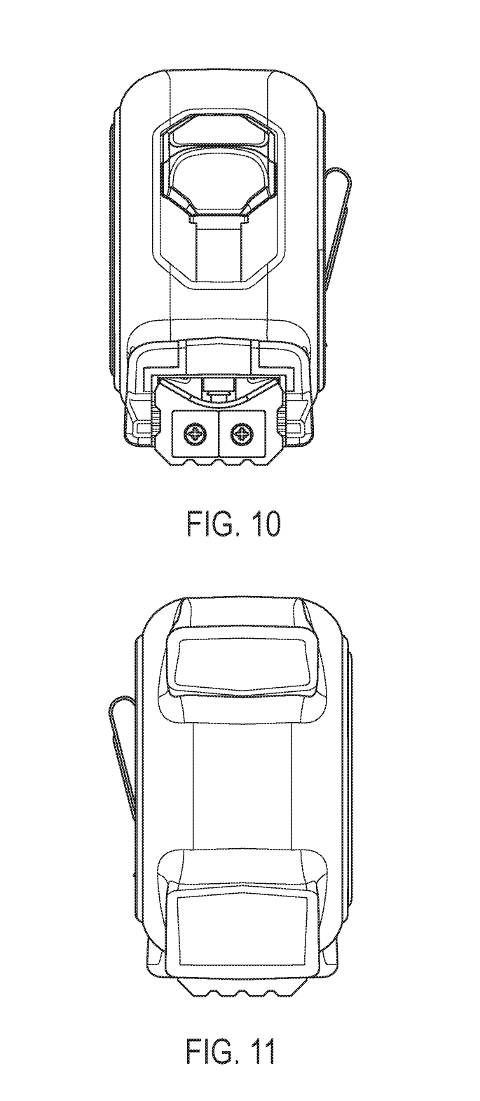

FIGS. 6-11 are views of a tape measure showing its aesthetic design from various perspectives.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A retractable tape, comprising:
an enclosure having a slot;
a tape having an elongate shape along a lengthwise direction, the tape having a first end rotatably attached to the enclosure and a second, free end disposed through the slot, the tape configured to be coiled into the enclosure and to extend therefrom through the slot, the tape having a first side that includes indicia and a second side;
wherein the indicia are disposed along the first of the tape at regular, predefined intervals, the indicia including a first plurality of indicia having a first width along the lengthwise direction and a second plurality of indicia having a second width along the lengthwise direction, the second width being larger than the first width.

2. The retractable tape of claim 1, wherein the indicia are arranged along the tape in the lengthwise direction in fixed intervals that denote standard measurement units.

3. The retractable tape of claim 2, wherein the measurement units are U.S. Customary measurement units that include inch markings, half-inch markings, quarter-inch markings and sixteenth-inch markings.

4. The retractable tape of claim 3, wherein the half-inch markings and quarter-inch markings belong in the second plurality of indicia.

5. The retractable tape of claim 3, wherein the inch and sixteenth-inch markings belong in the first plurality of indicia.

6. The retractable tape of claim 1, wherein each of the first plurality of indicia is made by a painted line that extends across the lengthwise direction.

7. The retractable tape of claim 1, wherein each of the second plurality of indicia is embossed and protrudes away from the first side of the tape.

8. The retractable tape of claim 1, wherein each of the second plurality of indicia is etched and extends concavely into the first side of the tape.

9. The retractable tape of claim 1, wherein each of the second plurality of indicia is embossed, protrudes away from the first side of the tape and has a semi-circular cross section across the lengthwise direction.

10. The retractable tape of claim 1, wherein each of the second plurality of indicia is embossed, protrudes away from the first side of the tape and has a triangular cross-section across the lengthwise direction.

11. The retractable tape of claim 1, wherein each of the second plurality of indicia extends concavely into the first side of the tape as a channel and has a semi-circular cross section.

12. The retractable tape of claim 1, wherein each of the second plurality of indicia extends concavely into the first side of the tape as a channel and has a triangular cross section.

13. The retractable tape of claim 1, wherein each of the second plurality of indicia is deposited in the first side of the tape using a fluorescent paint or material.

14. The retractable tape of claim 1, wherein the first and second pluralities of indicia are printed on the first side of the tape using paints of different colors.

15. The retractable tape of claim 1, wherein the first and second pluralities of indicia are printed on the first side of the tape using a same color paint but at different darkness.
